(19) United States
(12) Patent Application Publication
(10) Pub. No.: US 2007/0179860 A1
(43) Pub. Date: Aug. 2, 2007

(54) Motor vehicle remarketing service

(76) Inventor: Craig Duncan Romero, Altamonte Springs, FL (US)

Correspondence Address: CRAIG DUNCAN ROMERO, 307 BARCLAY AVENUE, ALTAMONTE SPRINGS, FL, 32701, US

(21) Appl. No.: 11/343,184

(22) Filed: Jan. 30, 2006

(51) Int. Cl. G06Q 30/00

(52) U.S. Cl. 705/26

(57) ABSTRACT

A method of marketing privately owned motor vehicles. The method is accomplished by use of electronic-commerce architecture in combination with a professional car care industry. The electronic-commerce architecture enables the thousands of brick-and-mortar professional car care enterprises to morph into one hybrid model resulting in a branded service that is national in its reach while local in its execution, whereby consumers may arrive at true market value with real-time-inventory listings of privately owned motor vehicles. The invention provides 1) a method of documenting consumer meetings while providing a relatively safe and neutral location whereby consumers may meet to inspect, negotiate and finalize an exchange; 2) a method of monitoring, quickly identifying, and enforcing the prohibition against used car dealer, used car broker, and curbstoner participation in any fashion; and 3) a national platform for green-marketing the benefits of professional car care versus individual car care alternatives.

### REFERENCES CITED

1. The Accidental Consumer by Karen Reyes, Modern Maturity (magazine), November-December 1999, pg. 96
2. THE KEY TO CAR-BUYING SUCCESS by Nicole Shotland, Internet Business (magazine), October 1998, pgs. 74-79, at pg. 74
3. Car shoppers find a lot to complain about by Toby Manthey, StatesmanJournal.com (webpage), May 29, 2005 (Source: Statesman Journal), http://159.54.226.83/apps/pbcs.dll/article?AID=/20050529/BUSINESS/505290345/1040
4. California checks on AutoNation charges by Earle Eldridge, USA Today (newspaper), Jun. 22, 2000, pg. 02.B
5. AG REILLY REACHES SETTLEMENT WITH NORTH SHORE USED CAR DEALERSHIPS, THE OFFICE OF MASSACHUSETTS ATTORNEY GENERAL Tom Reilly (webpage), Mar. 31, 2005 (Published: Feb. 18, 2005), http://www.ago.state.ma.us/sp.cfm?pageid=986&id=1377
6. City busts shady used-car dealers by Fran Spielman, suntimes.com (webpage), Sep. 24, 2005 (Source: Chicago Sun-Times), http://www.suntimes.com/output/news/cst-nws-auto24.html
7. Making the Trade by Jerry Edgerton, Money (magazine), May 2000, pgs. 155-158
8. Beware of car dealership trade-in tricks by Capt. Eric Hanson, Casemate (webpage), Mar. 31, 2005 (Source: FORT MONROE JUDGE ADVOCATE OFFICE), http://tradoc.monroe.army.mil/casemate/stack/010705carscams2.htm
9. Buyers left owing on vehicles they traded by Chris McKenna, record online (webpage), Jul. 5, 2005 (Source: Times-Herald Record), http://www.recordonline.com/archive/2005/07/05/cars05.htm
10. Penalties capped on car dealerships by Sarah A. Webster, Detroit Free Press (webpage), Mar. 31, 2005 (Published: Dec. 1, 2004), http://www.freep.com/money/auto news/dealers1e_{—}20041201.htm
11. Consumer Reports' Auto Price Service Study Finds Dealers May Leave Consumers in the Dark on Special Rebates, Financing Offers, U.S. Newswire—Medialink Worldwide (webpage), Aug. 4, 2005 (Published: Dec. 29, 2004—Source: Consumer Reports), http://releases.usnewswire.com/GetRelease.asp?id=41066
12. A Consumer Reports Auto Price Service Survey Find Majority of Car Buyers at Risk for Dealer Deceptions, U.S. Newswire—Medialink Worldwide (webpage), Aug. 4, 2005 (Published: Dec. 3, 2004-Source: Consumer Reports), http://releases.usnewswire.com/GetRelease.asp?id=40320
13. About Certified Pre-Owned-What it is, how it works and which type is best; page 1 of 3 by Staff, AUTOWEB.COM (webpage), Mar. 31, 2005 (Source: ABT), http://www.autoweb.com/content/buy/used/cpo/index.cfm?id=13171;TAWEB&action=showCPOArticle&AID=138942
14. Greedy salesman loses ‘decent profit’ by pushing warranty by Dan Jedlicka, Chicago Sun-Times (webpage), Mar. 31, 2005 (Published: Dec. 13, 2004), http://www.sun times.com/output/auto/car-news-letters13.html
15. Study: Used Vehicle Certification Programs Increase in Popularity, Road & Travel Magazine (webpage), Mar. 31, 2005 (Source: J.D. Power and Associates), http://www.roadandtravel.com/buyingausedcar/usedcar certifiedstudy.htm
16. McClellan & Gomez Announces Class Action Suit Filed Against Ford Motor Co. for Alleged Fraud in Certified Pre-Owned Used Car Program, Yahoo! (webpage), Aug. 5, 2005 (Published: Jun. 23, 2005-Source: Business Wire), http://biz.yahoo.com/bw/050623/235781.html?.v=1
17. ‘Certified’ used cars subject of suits by Kim-Mai Cutler, MyrtleBeachOnine.com (webpage), Jul. 17, 2005 (Source: The Wall Street Journal), http://www.myrtlebeachonline.com/mid/myrtlebeachonline/business/12155 499.htm
18. Buying used cars . . . the good, the bad, and the ugly by Capt. Eric Hanson, Casemate (webpage), Mar. 31, 2005 (Source: FORT MONROE JUDGE ADVOCATE OFFICE), http://tradoc.monroe.army.mil/casemate/stack/020405carscams3.htm
19. Is buying extended service agreement best for you or store?, THE ARIZONA REPUBLIC (webpage), Feb. 21, 2005, http://www.azcentral.com/arizonarepublic/local/articles/0221action21.html (file:///C|/Documents %20and%20Settings/JERRY/My%20Documents/Is%20Buyiing%20extended%20service%20agreement%20best/%20for/%20you%20or%20store.htm) (Apr. 1, 2005)
20. 5 Reasons Not To Buy An Extended Warranty by Mark Huffman, consumeraffairs.com (webpage), Nov. 14, 2005, http://www.consumeraffairs.com/news04/2005/extended-warranty.html
21. Carfax Team Up to Give Buyers Peace of Mind, Onlypunjab.com (webpage), Aug. 4, 2005 (Published: Dec. 11, 2004—Source: Advertising and Business News), http://www.onlypunjab.com/fullstory0105-insight-Carfax . . . m+Up+Give+Buyers+Peace+Mind-status-20-newsID-6102.html
22. Free Carfax Vehicle History Reports on AutoTrader.com: Manufacturers Offer Free Reports On Certified Pre-Owned Vehicles, CARFAXIn The News (webpage), Aug. 4, 2005 (Published: Feb. 10, 2005-Source: Carfax), http: //home.businesswire.com/portal/site/carfax/index . . . 1001925&newsLang=en&beanID=1480453143&viewID=news_View
23. Carfax to Make Database Available to New Orleans Consumers During Industry Conference; 20,000 Auto Dealers Converge on City Jan. 29-Feb. 1, TMCnet.com (webpage), Aug. 4, 2005 (Published: Jan. 19, 2005-Source: Business Wire), http://www.tmcnet.com/usubmit/2005/Jan/1109461.htm
24. Hidden Frame Damage Poses Serious Safety Risk to Drivers; Carfax Spokesperson Available to Provide Insight on These Unsafe Vehicles, CARFAXIn The News (webpage), Aug. 4, 2005 (Published: Apr. 29, 2005-Source: Carfax), http://home.businesswire.com/portal/site/carfax/index . . . 1001925&newsLang=en&beanID=11480453143&viewID=news_view
25. Wrecks in Disguise-How to Avoid Being Cheated on Used Cars, Road& Travel (webpage), Mar. 31, 2005 (Source: Consumer Reports), http://www.roadandtravel.com/consumerreports/carwrecksindisguise.htm
26. ‘Washed’ titles whisk away evidence of damage, JSOnline—Milwaukee Journal Sentinel (webpage), Apr. 3, 2005 (Published: Feb. 23, 1999-Source: Washington Post), http://www.jsonline.com/wheels/peak/wash21899.asp
27. Car-title fraud investigation expands by Peyton Whitely, The Seattle Times—SNOHOMISH COUNTY (webpage), Apr. 13, 2005 (Source: Times Snohomish County Bureau), http://seattletimes.nwsource.com/html/snohomishcountynews/2002239170_title13n.html
28. Wrecks on the road by Dan Olson, Minnesota Public Radio (webpage), Dec. 20, 2005, http://news.minnesota.publicradio.org/features/2005/12/15_olsond_autoscams/
29. State Farm to pay some used-car buyers $40 million over vehicle titles by Candace Heckman, seattlepi.com (webpage), Mar. 31, 2005 (Published: Jan. 11, 2005), http://seattlepi.nwsource.com/local/207398_usedcars11. html
30. Fine Print Binds Car Buyers by Brian Ross and Jill Rachmill, ABCNews (webpage), Mar. 31, 2005 (Published: Feb. 23, 2005), http://abcnews.go.com/WNT/Business/story?id=526106&page=1
31. EDWARD LAPHAM COMMENTARY Oct. 14, 2005: It's universal—used_car shoppers like private deals by Edward Lapham, Automotive News (webpage), Oct. 14, 2005, https://www.autonews.com/buy Archives.cms?newsId=13567
32. Montgomery cracks down on ‘curbstoners’ by Arlo Wagner, The Washington Times (webpage), Apr. 12, 2005, http://washingtontimes.com/metro/20050411-100134-9362r.htm
33. Old scam called curbstoning gets new life on the Web by Peter Lewis, The Seattle Times (webpage), Jul. 18, 2005, http://seattletimes.nwsource.com/html/localnews/2002387550_curbstoner18m.html
34. Blame for broken skylight can't be laid at painter's feet-Car trouble by Nancy Paradis, St. Petersburg Times ACTION ONLINE (webpage), Oct. 16, 2005, http://www.sptimes.com/2005/10/16/Action/Blame_for_broken_skyl.shtml
35. NIADA Report: More Independent Dealers, Greater Share of Used Car Market, Automotive Digest (webpage), Jul. 10, 2005 (Published: Jun. 20, 2005-Source: Used Car News), http://www.automotivedigest.com/view_art.asp?articlesID=16199
36. Car dealers cashing in on finance commission by Rob Stock, Stuff (webpage), Sep. 25, 2005, http://www.stuff.co.nz/stuff/0,2106,3422831a13,00.html
37. Deals on Wheels by Bob Calandra, P.O.V. (magazine), September 1999, pgs. 58-59, at pg. 58
38. Research and Markets: The Boom Continues For Online Auto Advertising, Research And Markets (webpage), Aug. 2, 2005 (Source: Business Wire), http://home.businesswire.com/portal/site/google/index.ndmViewID=news_view&newsid=20050802005502&newsLang=en
39. NORTH CENTRAL FLORIDA EDITION AUTO TRADER, Auto Trader® (magazine), Jan. 21-27, 2005, Issue # 03, pg. 4
40. Locations, Auto Trader Magazines—Canton (webpage), Apr. 5, 2005, http://akron canton.cws.traderpub.com/locationandhours.html
41. AutoTrader.com and Yahoo! Autos Announce Exclusive Used Car Classifieds Relationship, PR Newswire (webpage), Mar. 31, 2005 (Published: Jun. 30, 2004), http://www.prnewswire.com/cgi-bin/stories.pl?ACCT=109&STORY=/www/story/01-04-2005/0002767034&EDATE=
42. BY OWNER USED CAR SALES SOAR, Road & Travel (webpage), Mar. 31, 2005, http://www.roadandtravel.com/newsworthy/newsandviews04/usedcarsalessoar.htm
43. Smart Buying Essentials-Unloading Your Old Car, IntelliChoice (webpage), Mar. 31, 2005, http://www.intellichoice.com/carBuying101/Unloading OldCar
44. Man shot, says he was buying a car by Pauline Repard, SignOnSanDiego.com (webpage), Mar. 31, 2005 (Published: Jan. 21, 2005-Source: Union Tribune), http://www.signon sandiego.com/news/metro/20050121-9999-6m21 scrime.html
45. Women's ranks continue to grow in retail car business byjohn Porretto, Daily Southtown (webpage), Feb. 14, 2005 (Published: Jan. 13, 2005-Source: The Associated Press), http://www.dailysouthtown.com/south town/dsbiz/131 bd2.htm
46. Safety and Crime Prevention-Auto Theft Prevention-Tips For Purchasing a Used Vehicle From a Private Party, CITY OF SCOTTSDALE ARIZONA (webpage), Aug. 4, 2005, http://www.scottsdaleaz.gov/safety/buyauto.asp
47. Seller Beware, things you need to watch out for . . . by Ben Freeland, Straight Away (webpage), Mar. 31, 2005, http://www.straight-away.com/news article_detail.asp?ArticleID=300
48. Safety and Crime Prevention-Tips for Selling a Used Vehicle to a Private Party, CITY OF SCOTTSDALE ARIZONA (webpage), Aug. 4, 2005, http://www.scottsdaleaz.gov/safety/sellauto.asp
49. The New Realities of Used-Car Shopping by Ed Henry, Kiplinger's Personal Finance Magazine (magazine), June 1999, pgs. 86-90, at pgs. 88-90
50. Driving a Deal Online by Jerry Edgerton, Money (magazine), September 1999, pgs. 177-179
51. BUYING A CAR WITHOUT THE OLD HASSLES by John Greenwald, Time (magazine), Mar. 18, 1996, pgs. 74-75
52. click your wheels by Jeff Garigliano, SmartMoney (magazine), October 1999, pgs. 133-134, at pg. 133
53. HITTING THE WEB by Ed Henry, Kiplinger's Personal Finance Magazine (magazine), July 2000, pgs. 112-115, at pg. 114
54. HIDDEN AGENDA by Sarah Breckenridge, SmartMoney (magazine), April 2000, pg. 86
55. THE 2000 CARS: BEST OF THE REST by Kathy Jones and James Ramage, Kiplinger's Personal Finance Magazine (magazine), December 1999, pgs. 86-92, at pg. 92
56. ONLINE Car-Shopping Guide by Michelle Krebs, Consumers Digest (magazine), January/February 1998, pgs. 81-83, at pg. 83
57. AUTOTRADER FRAUD by John Matarese, WCPO.com (webpage), Dec. 15, 2005, http://www.wcpo.com/wcpo/localshows/dontwasteyourmoney/1e79bb75.html
58. Dealer Specialties Partners with Auto Mart Magazines on AutoMart.com Offers Customers, Onlypunjab.com (webpage), Aug. 4, 2005 (Published: Dec. 5, 2004—Source: Business News), http://www.onlypunjab.com/full story0105-insight-Dealer+Specialties+Partners+with+Auto-status-25-newsID-24.html
59. No.1 Source In Finding Auction Car Bargains, CHEAPCarFinder.com (webpage), Mar. 31, 2005, http://www.cheapcarfinder.com/?hop=cache
60. Online car auctions are booming, but some deals are too good to be true by Paul Wenske, NorthJersey.com (webpage), Mar. 31, 2005 (Source: The Kansas City Star), http://www.northjersey.com/page.php?qstr=eXjpcnk3Z jczN2Y3dnFIZUVFeXkxNjcmZmdiZWw3Zjd2cWVIRUV5eTY2NTIOMzYmeXJpc nk3ZjcxN2Y3dnFIZUVFeXk3
61. USED CARS. NEW MODEL by Cheryl Dahle, Fast Company (magazine), July 2000, pgs. 316-326
62. Conference Examines Impact of Internet Remarketing, Automotive Digest (webpage), Jun. 28, 2005 (Published: Jun. 15-30, 2005-Source: Auto Remarketing), http://www.automotivedigest.com/view_art.asp? articlesID=16067
63. Research and Markets: Launching the Automobile Industry Almanac 2005, PR Newswire (webpage), Apr. 5, 2005 (Published: Mar. 15, 2005-Source: Research and Markets), http://www.prnewswire.com/cgi-bin/stories. p1?ACCT=109&STORY=/www/story/03-15-2005/0003196687&EDATE=
64. Electronic commerce, myWiseOwl.com (webpage), Apr. 3, 2005, http://www.mywiseowl.com/articles/Electronic-commerce
65. Buyers go online to research makes and models, but most close the deal face to face by Tom Incantalupo, Newsday.com (webpage), Jul. 3, 2005, http://www.newsday.com/business/ny-bzcov4327753jul03,0,7119192. story?page=1 &coll=ny-business-headlines
66. IN GEAR by Jay Whittaker, The Industry Standard (magazine), Nov. 15, 1999, pgs. 34-36, at pg. 34
67. Bricks and clicks business model, myWiseOwl.com (webpage), Apr. 3, 2005, http://www.mywiseowl.com/articles/Bricks_and_clicks_business_ model
68. INTERNATIONAL CARWASH ASSOCIATION AT-A-GLANCE, CARLOVE—CAR WASH FACTS—ICA FactSheet (webpage), Mar. 31, 2005, http://www.carlove.org/news/icasheet.cfm
69. THE CAR DEALERSHIP WASH GUYS, The Car Wash Guys (webpage), Mar. 31, 2005, http://www.carwashguys.com/dealershipdiv.shtml
70. Environmental Information, Images Car Care—Car Care Info (webpage), Apr. 2, 2005, http://www.imagescarcare.com/carcareinfor_{—}04.asp
71. Professional Car Washes are more Environmentally Friendly, CARLOVE—CAR WASHFACTS (webpage), Apr. 1, 2005, http://www.carlove.org/facts/benefittwo.cfm
72. Seattle Times Article Proclaims Commercial Car Washes Use Less Water than Home Washes, International Carwash Association (webpage), Aug. 3, 2005, http://www.carcarecentral.com/pgRenderPage.asp? . . . CBCC7B14%2 DB49C %2D44B6%2D919E%20DC9AA9632B655%7D
73. Let's Say Goodbye to Driveway Washers by Mark Curtis, Modern Car Care (webpage), Apr. 1, 2005, http://www.moderncarcare.com/Articles/111 persp.html
74. Pollution Prevention/Good Housekeeping for Municipal Operations, United States Environmental Protection Agency—National Pollutant Discharge Elimination System (NPDES) (webpage), Apr. 1, 2005, http://cfpub.epa.gov/npdes/stormwater/menuofbmps/poll_{—}18.cfm
75. ICA study a mixed bag for professional carwashes by Adam Doling, Professional Car care Online (webpage), Apr. 1, 2005 (Published: April 2003-Source: Professional Carwashing & Detailing magazine), http://www.carwash.com/article.asp?IndexID=_{—}6633537
76. Stonyfield Farm Exemplifies New Green Marketing Model by Jacquelyn A. Ottman, Green Marketing and Eco-Innovation (webpage), Apr. 1, 2005, http://www.greenmarketing.com/articles/amajan98.html
77. Need for Information by Jacquelyn A. Ottman, Green Marketing: Opportunity for Innovation (webpage), Apr. 1, 2005 (Published: 1998), http://www.greenmarketing.com/Green_Marketing_Book/Chapter02.html
78. Guzzler's Remorse-Gas hikes curb appeal of SUVs as lots try to sell by Ben van der Meer, modbee.com (webpage), Oct. 30, 2005 (Source: The Modesto Bee), http://www.modbee.com/business/story/11417480p-12161551 c.htm
79. How to Sell Your Car-4. Get Your Car Ready, abc72.com (webpage), Oct. 26, 2005, http://abclocal.go.com/wjrt/story?section=automotive&id=60402
80. Edmunds.com to Provide Enhanced Automotive Photography to Car Industry, mysan.de/international (webpage), Feb. 3, 2005, http://www.mysan.de/international/article31495.html

### BACKGROUND

The invention relates to a method of marketing privately owned motor vehicles.

Definition List 1

| Term | Definition |
|---|---|
| motor vehicle | A self-propelled wheeled conveyance, |
| | such as a car or truck that does not ride |
| | on rails. |

The used car market is an inefficient, fragmented market. The current state of the market presents the consumer with a daunting choice of soliciting the services of a used car dealer or used car broker; placing a for-sale-signed motor vehicle in a public or private locale to draw response from local traffic; employing the utility of conventional classified advertisement through print media; and/or employing the utility of online classified advertisement or auction through a website or website-only method of service.

“Used car dealers top a list of 15 professions and industries that consumers believe consistently mislead or try to take advantage of them.” [The Accidental Consumer, 1] Dealers are perceived as swindlers, and the cars as lemons, with “no possible way to avoid being ripped off.” [THE KEY TO CAR-BUYING SUCCESS, 2] Such perception is not without good cause. [Car shoppers find a lot to complain about, 3; also see, e.g., California checks on AutoNation charges, 4; AG REILLY REACHES SETTLEMENT WITH NORTH SHORE USED CAR DEALERSHIPS, 5; City busts shady used-car dealers, 6] A trade-in may subject the consumer to an even greater loss. [Making the Trade, 7; Beware of car dealership trade-in tricks, 8] Moreover, “[c]ar buyers who trade in their old vehicles and count on the dealer to retire their outstanding loans occasionally discover later that the dealer has done no such thing. Suddenly, they're stuck with payments, not only on their new cars or trucks but on ones they thought they'd gotten rid of. *** And woe to those who unwittingly buy a used car with an unpaid loan lurking in its history. They might just lose it to the repo man, . . . ” [Buyers left owing on vehicles they traded, 9] “People know there are dishonest car dealers out there.” [Penalties capped on car dealerships, 10] “Many dealerships prey on the unprepared.” [Consumer Reports' Auto Price Service Study Finds Dealers May Leave Consumers in the Dark on Special Rebates, Financing Offers, 11] “[I]t's the consumers who ultimately pay the price for not knowing where to shop for the best car, how to negotiate, and how to protect themselves from predatory practices.” [A Consumer Reports Auto Price Service Survey Finds Majority of Car Buyers at Risk for Dealer Deceptions, 12] At the very least, the car business may appear to be an opportunistic enterprise. But with limited alternatives, consumers have continued to solicit such services.

The used car dealer is considered by some to be quite creative in bringing new versions of the same old scam, the latest one being the so-called Certified Pre-Owned motor vehicle. “Technically, certification is the same thing as a warranty. A certified vehicle is one that has passed a series of published tests by the seller who is willing to support the inspection with a warranty.” [About Certified Pre-Owned-What it is, how it works and which type is best: page 1 of 3, 13] Critics complain that “it's a marketing ploy, a sleight-of-hand trick that gets [the consumer] to pay for a useless piece of paper.” Id. [e.g., Greedy salesman loses ‘decent profit’ by pushing warranty, 14] “On average, luxury buyers paid nearly $3,000 more for their certified used vehicle than did buyers of non-certified luxury brands, while non-luxury buyers paid $1,000 more,” for what may amount to nothing more than a piece-of-mind premium. [Study: Used Vehicle Certification Programs Increase in Popularity, 15] A reasonable conclusion may be that “consumers [should not] be spending billions of dollars a year for a perceived benefit that does not exist[.]” [McClellan & Gomez Announces Class Action Suit Filed Against Ford Motor Co. for Alleged Fraud in Certified Pre-Owned Used Car Program, 16] Certified “used-car programs are coming under increasing attack from consumer advocates and lawmakers . . . ” [‘Certified’ used cars subject of suits, 17] In this light, the consumer must also “[b]e cautious of dealer-offered extended warranty plans. They are often too expensive and offer too little protection.” [Buying used cars . . . the good, the bad, and the ugly, 18; also see, Is buying extended service agreement best for you or store?, 19; Five Reasons Not To Buy An Extended Warranty, 20]

Another alleged piece-of-mind gimmick incorporated and touted by the used car dealer is a provider of vehicle history information. [e.g., Carfax Team Up to Give Buyers Peace of Mind, 21; Free Carfax Vehicle History Reports on AutoTrader.com: Manufacturers Offer Free Reports On Certified Pre-Owned Vehicles, 22] It genuinely appears that consumer protection is the business of Carfax® as the company demonstrates an ongoing concern to address elements of industry fraud, and promotes consumer awareness. [Carfax to Make Database Available to New Orleans Consumers During Industry Conference, 20.000 Auto Dealers Converge on City January 29-February 1, 23; Hidden Frame Damage Poses Serious Safety Risk to Drivers: Carfax Spokesperson Available to Provide Insight on These Unsafe Vehicles, 24] The problem lies not with Carfax and its progeny but with the willful or otherwise failure of insurance companies and the states' Department of Motor Vehicles (DMV) to report and document motor vehicles with a tainted history. Moreover, once vehicle damage is documented on a title, subsequent removal of such disclosure defeats the purpose.

A Consumer Reports® six-month investigation found that “[t]here's no way for consumers to know for sure the history of a used vehicle” and “[o]verall, 30 percent of vehicles that had been totaled after a fatal accident and then put back on the road with a title that disclosed the damage had that disclosure subsequently removed.” [Wrecks in Disguise-How to Avoid Being Cheated on Used Cars, 25]

Mercenary auto insurance adjusters and inspectors may stimulate the criminal element of auto salvagers, who actively seek to obtain totaled or major-damaged, high-resale-valued motor vehicles where titles may be washed and placed back into the used car market. [‘Washed’ titles whisk away evidence of damage, 26; also see, Car title fraud investigation expands, 27; Wrecks on the road, 28] Dealers, whether willingly or unknowingly, accept such motor vehicles onto their lots with the Carfax-clean seal of approval, making illegitimate profits at the expense and safety of the consumer. The problem is rampant. [e.g., State Farm to pay some used-car buyers $40 million over vehicle titles, 29] To make matters worse, the consumer who has purchased a totaled or major-damaged motor vehicle from a dealer usually has little recourse. The consumer without good vision and legal expertise is subject to have glossed over the fine print in a binding contract and, unknowingly, sign off on a right to sue in a court of law. Thus, the consumer with a legitimate complaint is usually forced into arbitration, which is presumed to have little, if any, effect on an unscrupulous dealer's motis operandi. [Fine Print Binds Car Buyers, 30]

Given an informed choice, the smart consumer may more likely be willing to accept the risk of a private transaction with an as is motor vehicle (of course, with the option of securing a pre-purchase vehicle inspection by an independent mechanic—a course of action costing roughly $75 to $150 that can save consumers thousands of dollars down the road) than to engage an arms-length deal with a used car dealer for an alleged Carfax-clean, so-called Certified Pre-Owned motor vehicle with a substantially higher price and risk for a comparative motor vehicle. This is not to imply that a vehicle history check should be abandoned in a private transaction—a private transaction simply may reduce the risk that Carfax® or any other competitive vehicle history reporter may be implemented by an unethical dealer for the perpetration of fraud.

“It's universal—used-car shoppers like private deals” [EDWARD LAPHAM COMMENTARY Oct. 24, 2005: It's universal—used-car shoppers like private deals, 31] Nevertheless, the smart consumer must proceed with caution in a private transaction. The appearance of a private transaction may be nothing more than a curbstoner's deception. [Montgomery cracks down on ‘curbstoners’, 32] Old-economy curbstoners operate on the curb with for-sale-signed motor vehicles, but “[a] growing number favor the Web, where it's easier for sellers to conceal their identity and location from unsuspecting buyers . . . ” [Old scam called curbstoning gets new life on the Web, 33] “When buying a used car, it is always advisable to take the car to a trusted, independent mechanic for evaluation. If the seller, since this applies to private sales as well, won't allow your mechanic to inspect the car, walk away quickly.” [Blame for broken skylight can't be laid at painter's feet-Car trouble, 34]

Notwithstanding dealer profits made in the so-called Certified Pre-Owned program, independent dealers reportedly make an average retail profit at $489 per unit. [NIADA Report: More Independent Dealers, Greater Share of Used Car Market, 35] Although such an amount is not unreasonable, in and of itself, commissions increase considerably when financing is arranged and even bigger when “cash back” is sold. [Car dealers cashing in on finance commission, 36]

A used car broker may be considered as an alias for the used car dealer. The used car broker intends to make a substantial profit at the expense of the consumer. [Deals on Wheels, 37]

Placement of a for-sale-signed motor vehicle in a public or private locale to draw response from local traffic is a method commonly employed by the consumer in this fragmented market. Several inferior characteristics exist in the utility of this method in common with other methods comprehensively described and fully addressed below. The most apparent drawback to such a method may be the limited amount of exposure the motor vehicle ultimately receives. This may result in a limited and belated response (if any). While a seller may employ this method to avoid associated costs and expenses of placing a motor vehicle on the market by alternative methods, the limited exposure and dilatory response, may ultimately have a contrarily profound effect upon the final sale price.

Conventional classified advertisement through print media possesses several inferior characteristics. The used car marketing process can be a long and complicated one when utilizing print media. Advertisement through the classified section of a local or national newspaper is a typical example. Newspaper automotive classifieds are narrowly focused with limited market area. The initial ad placement process is inconvenient, at best, consuming a substantial amount of time. The inconvenience is compounded by the traditional amount of time that must be normally invested by consumers while searching for a motor vehicle of interest, and making initial contact as well as the subsequent making of time-and-location arrangements for inspection, negotiation, and the final exchange. The tangible value is minimal while advertisement space is sold at a premium. Brand name recognition and image is nonexistent as is the case of consumer loyalty.

Over the last few years, there has been a massive audience shift toward the Internet. Online campaigns are stealing ad share from newspapers. “Among Internet users, 11 percent said they found the used car they ultimately bought online, while only 9 percent said they found their car in a newspaper classified.” [Research and Markets: The Boom Continues For Online Auto Advertising, 38]

Auto Trader® Magazine and its progeny is an example of as-good-as-it-gets with print media for the consumer rejecting the idea of an arms-length experience with a used car dealer. The only page available for placement of a picture in full color is the front page which holds four listings. It is available on a weekly basis at a premium price. Placement of gray-scale half-tone, single-sized, double-sized, and four-time-sized pictures can be accomplished on a two-week, twelve-week, and unlimited basis. In sales, a great picture can say a thousand words. In the case of Auto Trader® Magazine, although all advertisement space is sold at a premium, the pictures (with the exception of the front cover) are of such poor quality that they serve no legitimate purpose other than to help identify the make and model of motor vehicle advertised for sale.

A consumer wishing to place a motor vehicle for sale with Auto Trader Magazine can choose to schedule an appointment, free of charge, with a photographer to visit one's home or office, or to visit the company's office or a local Photo Express Center and have them take the photo. [NORTH CENTRAL FLORIDA EDITION AUTO TRADER, 39] Regardless of choice, the consumer can expect to experience the inconvenience 1) of awaiting the arrival of a photographer at the consumer's location of choice, or 2) during a, sometime, tumultuous search while driving to an unbranded Photo Express Center (no Auto Traders signage) sparsely established in local areas, such as oil change/quick lube shops, motor vehicle aftermarket parts stores, car washes, and print shops, to name a few. [Locations, 40] This inconvenience is relevant to the initial placement of a motor vehicle for sale on Auto Trader® Magazine. The inconvenience is compounded by the traditional amount of time that must be normally invested when utilizing print media, as mentioned in the prior example of placement of an advertisement in a classified section of a newspaper. Moreover, in the event the motor vehicle has been sold, the seller usually becomes the recipient of late inquiries from consumers due to the nature of dated listings inherent in print media. Unlike Auto Trader Magazine, newspapers, and their progeny, the invention strictly provides real-time-inventory. Once sold, the privately listed motor vehicle shall be removed from the database, forthwith.

Finally, it is clear that Auto Traders Magazine and its offspring (including the online version) is dealer-driven—“40,000 dealers” with more than 2.25 million listings versus 250,000 listings by private parties. [AutoTrader.com and Yahoo! Autos Announce Exclusive Used Car Classifieds Relationship, 41] This may amount to lost time for buyers searching through dealer trappings for the minority listings of privately owned motor vehicles, a substantial number of which may be dated, as addressed above.

“Since 1999 the person-to-person auto sales have risen 20% going from 11,448,430 units to over 13,668,383 units in 2003, while used car sales by New Car Dealers have declined.” [BY OWNER USED CAR SALES SOAR, 42] A major concern may exist for the security of consumers who choose to engage a private transaction for the sale or purchase of a motor vehicle. Most consumers may prefer to meet at a location other than their personal residences. In particular, “[s]ellers who live alone, or who feel vulnerable in some way, may be unwilling to open up their garages, and perhaps their homes, to strangers shopping for used cars.” [Smart Buying Essentials-Unloading Your Old Car, 43] This may leave the proverbial meeting ground out in the street where bad things can happen. [e.g., Man shot, says he was buying a car, 44] Women may be particularly vulnerable who “act alone or have a say in roughly 80 percent of all vehicle purchases.” [Women's ranks continue to grow in retail car business, 45] In consideration of consumer safety and crime prevention, consumers may:
Not invite an unknown buyer to the home.
Not meet the seller in an unsafe location.
Choose a safe, neutral meeting ground in a public location.
Inspect all vehicle numbers for a match—VIN and license plate.
Be sure that both buyer and seller possess a valid driver's license and photo.
Be sure that both buyer and seller possess a valid insurance card.
Compare the seller's driver license information to the vehicle registration.
Not consider a test drive until confidence in the buyer is legitimate; then leave identification information on both with someone who is not going on the test drive—copies if possible.
   [Safety and Crime Prevention—Auto Theft Prevention—Tips For Purchasing a Used Vehicle From a Private Party, 46; Seller Beware, things you need to watch out for . . . , 47; Safety and Crime Prevention-Tips for Selling a Used Vehicle to a Private Party, 48]

The evolution of the Internet has made way for a new reality in used-car shopping. [The New Realities of Used-Car Shopping, 49; also see, Driving a Deal Online, 50; BUYING A CAR WITHOUT THE OLD HASSLES, 51] First off, know that most of the online sites “are a lot alike, so much so that it's sometimes hard to tell them apart,” thus, “[w]hat ultimately separates one site from the next is its network of dealers.” [click your wheels, 52] Most of these sites “are referral services that simply take your name and pass it on to a dealer.” [HITTING THE WEB, 53; also see, HIDDEN AGENDA, 54; THE 2000 CARS: BEST OF THE REST, 55] Apparently, the Internet has proven to be a good place for “dealers to nab customers.” [ONLINE Car-Shopping Guide, 56]

There seem to be an almost endless number of websites that promote various methods in the marketing of motor vehicles. AutoTrader.com is a major player in the marketing of used vehicles although it “has become fertile ground for scams.” [AUTOTRADER FRAUD, 57] Automart.com claims to be the Internet's largest automotive website featuring used car listings exclusively from dealers. [Dealer Specialties Partners with Auto Mart Magazines on AutoMart.com Offers Customers, 58] Of course, the consumer can always elect to pursue online car auctions. [e.g., No.1 Source In Finding Auction Car Bargains, 59] But in doing so, the consumer must accept a considerable risk in becoming a victim of fraud. [Online car auctions are booming, but some deals are too good to be true, 60]

Dennis Berry, former president and CEO of Manheim Auctions, Inc., believes that his company has the best model. Mr. Berry was correct in stating that “physical infrastructure is integral to the process of buying and selling used cars,” thus, “[a] pure dotcom with no physical infrastructure or preexisting relationships—is naïve.” And it appears that the world-wide web does not remove the tedious and tension-filled give and take traditionally demanded to strike a good deal. But the Manheim Auctions, Inc., model may still miss the point. It appears that the model may be flawed by incorporation of the dealer. Mr. Berry stated, “A lot of dotcoms say, ‘We're going to bypass dealers. Consumers don't like doing business with dealers.’ We knew that wouldn't happen— . . . ” [USED CARS, NEW MODEL, 61; also see, Conference Examines Impact of Internet Remarketing, 62] The invention herein contradicts Mr. Berry's former prediction.

The Internet, the world-wide web, and electronic commerce appear to have brought regions together to create a national networked economy.

Definition List 2

| Term | Definition |
|---|---|
| Internet | An interconnected system of networks |
| | that connects computers around the |
| | world via the TCP/IP protocol. |
| world-wide web | An Internet client-server hypertext |
| | distributed information retrieval system |
| | which originated from the CERN High- |
| | Energy Physics laboratories in Geneva, |
| | Switzerland. |
| electronic commerce | The conducting of business |
| | communication and transactions |
| | over networks and through computers. |
| | As most restrictively defined, electronic |
| | commerce is the buying and selling of |
| | goods and services, and the transfer of |
| | funds, through digital communications. |
| | However EC also includes all inter- |
| | company and intra-company functions |
| | (such as marketing, finance, manufacturing, |
| | selling, and negotiation) |
| | that enable commerce and use electronic |
| | mail, EDI, file transfer, fax, video |
| | conferencing, workflow, or interaction |
| | with a remote computer. Electronic |
| | commerce also includes buying and |
| | selling over the World-Wide Web and the |
| | Internet, electronic funds transfer, smart |
| | cards, digital cash (e.g., Mondex), and all |
| | other ways of doing business over digital |
| | networks. |

The emergence of online markets and electronic business appear to have an effect on market structures, supply chains and company performance. The fact that the cost of information and communication continues to decline appears to have increased market transparency on some level, and speed of reaction reaches hitherto unknown dimensions. Electronic commerce particularly appears to be having a significant effect on the automobile industry where mergers, acquisitions, and changing-brands are in the news on a global scale. [Research and Markets: Launching the Automobile Industry Almanac 2005, 63] But, while any electronic-commerce venture may bring a number of key success factors into play, problems can still arise. [Electronic commerce, 64]

“More than half of car buyers use the Internet for research, but most close the deal the way it's always been done: face to face . . . ” [Buyers go online to research makes and models, but most close the deal face to face, 65] “[T]he direction for the future of car sales lies not in a completely faceless car-buying process, but in service [and] convenience . . . [p]eople have the money to buy cars; they just don't want to be had.” [IN GEAR, 66]

“Bricks and clicks is a business strategy or business model in e-commerce by which a company attempts to integrate both online and physical presences. It is also known as Click-and-mortar or clicks-and-bricks.” [Bricks and clicks business model, 67] Under the right circumstances, vision, and management, the leveraging-advantages of such a model can be quite profound. Such a model can lay the groundwork for the ultimate brand. Strategic branding is the essence of a successful business. A brand is the sum, in the consumer's mind, of the personality, presence, and performance of a given product or service.

A professional car care industry as classified with the United States Department of Commerce, Bureau of Census, Economic Census, North American Product Classification System (NAPCS), Sector 81—Other Services (Industries arranged by NAICS Sectors), specifically NAICS Code 811192 includes:
Automotive Detailing Services (i.e., cleaning, polishing)
Automotive Washing and Polishing
Car Detailers
Car Washes
Detailing Services (i.e., cleaning, polishing), Automotive
Mobile Car, Truck and Bus Washes
Self-Service Carwash
Truck and Bus Washes, and
Waxing and Polishing of Motor Vehicles

The professional car care industry offers a variety of services, consisting of:
Full-Service
Full-Service Conveyor
Detailing
Full-Service Detailing
Express Detailing
Exterior-Only
Exterior-Only Conveyor
In-Bay Automatic
Self-Service
Convenience Store
Gasoline
Oil Change/Quick Lube
Truck Rental
Oil Company Car Wash
Paintless Dent Repair
Gold Plating
Windshield Repair
Hand Car Wash
Window Tinting, and
Vinyl/Leather Repair, according to the professional car care industry.

It is estimated that there are 75,000 car washes in North America where consumers spend more than $22.2 billion annually to have their vehicles professionally cleaned. [INTERNATIONAL CARWASH ASSOCIATION AT-A-GLANCE, 68]

A professional car care enterprise has a division strictly dedicated to servicing dealerships in the automotive industry-new and used car dealerships, Internet auto sales companies, auto auctions, manufacturers, and on-site auto shows, as well as dealerships for RVs, boats, trucks, motorcycles and new farm equipment. [THE CAR DEALERSHIP WASH GUYS, 69]

The professional car care industry idealizes itself as the better solution in consistency with ecological and environmental concerns, that is to say, the industry green-markets the benefits of pollution control and water conservation through its use versus individual car care alternatives. [Environmental Information, 70; Professional Car Washes are more Environmentally Friendly, 71; Seattle Times Article Proclaims Commercial Car Washes Use Less Water than Home Washes, 72; Let's Say Goodbye to Driveway Washers, 73] The Environmental Protection Agency (EPA) also recognizes the environmental benefits of professional car care. [Pollution Prevention/Good Housekeeping for Municipal Operations, 74] “[B]ut many consumers are still price conscious and driveway washing regularly.” [ICA study a mixed bag for professional carwashes, 75]

Thus far, the professional car care industry has been unable to develop a meaningful, far-reaching method to promote its ecological and environmental benefits to the public, at large, even though concern about the environment encourages buying products and services that are ecologically friendly and reduce pollution. [Stonyfield Farm Exemplifies New Green Marketing Model, 76] “Providing such information and education still represents the biggest opportunity to expand the market to mainstream consumers.” [Need for Information, 77]

### SUMMARY

In accordance with the present invention a method of marketing privately owned motor vehicles. The method is accomplished by a novel and unobvious use of electronic-commerce architecture in combination with a professional car care industry.

Objects and Advantages

Accordingly, several objects and advantages of the present invention are:
A long desired, value-added solution-a nationwide, consumer-driven service whereby the consumer may arrive at true market value for a given motor vehicle by means of exclusive, real-time-inventory listings of privately owned motor vehicles;
A long desired, value-added solution-a quick, convenient, one-stop process for initiating the placement of a privately owned motor vehicle on the market;
A long desired, value-added solution-a relatively safe, neutral meeting ground for contact, inspection, negotiation, and the final exchange;
A service incorporating express prohibition with monitored enforcement against used car dealer participation in any fashion;
A service incorporating express prohibition with monitored enforcement against used car broker participation in any fashion;
A service incorporating express prohibition with monitored enforcement against curbstoner participation in any fashion;

Further objects and advantages of the invention become apparent from consideration of the ensuing description.

### DETAILED DESCRIPTION OF THE INVENTION

A preferred embodiment of the present invention is electronic-commerce architecture in combination with a professional car care industry.

The electronic-commerce architecture, comprising:
A multi-protocol, wide-area network including a central database and professional car care enterprise computer-workstations,
An interactive, service-mark branded, online site registered in a domain on the world-wide web, and
Further including any requisite hardware and application software necessary to conduct the operation and perform the service.

The professional car care industry, comprising an alliance of professional car care enterprises, including:
Car Washes
Truck and Bus Washes
Car Detailing Shops
Mobile Car, Truck and Bus Washes
Mobile Car Detailing
Self-Service Carwashes
Waxing and Polishing of Motor Vehicles; and
Further including any current, future and new type of professional car care enterprise not listed heretofore.
   Advantages

With the intention of attracting the most interest and increasing perceived value, a presumption exists that a privately owned motor vehicle will be “clean[ed] . . . as thoroughly as possible, inside and out . . . before [being] put on the market.” [Guzzler's Remorse—Gas hikes curb appeal of SUVs as lots try to sell, 78] From the description above, the advantages of the motor vehicle remarketing service are synergistically apparent. [How to Sell Your Car—4. Get Your Car Ready, 79] The novel and unobvious use of electronic-commerce architecture in combination with a professional car care industry provides:
A marriage that enables the thousands of brick-and-mortar professional car care enterprises to morph into one hybrid model;
A physical infrastructure integral to the process of buying and selling used motor vehicles;
A national platform for educating an ecologically and environmentally conscious society of the green-benefits of professional car care versus individual car care alternatives; and
A branded service that is national in its reach while local in its execution.
   Operation

A consumer markets a motor vehicle by bringing said vehicle along with a valid driver's license, proof of insurance, and motor-vehicle registration document to any one of the thousands of participating professional car care enterprises within the alliance or, in exercising the option of initiating the remarketing process at another designated location, seeking the services of a mobile-wash or mobile-detailing enterprise.

The consumer physically surrenders a driver's license, proof of insurance, and motor vehicle registration document to the service provider.

The service provider visually compares the name on the consumer's driver license and proof of insurance to the name on the motor-vehicle registration document. To document authenticity, an option may be to scan the driver's license, proof of insurance, and motor-vehicle registration document into the enterprise workstation for upload and temporary or permanent storage in the central database.

The service provider visually compares the number on the motor-vehicle registration document to the Vehicle Identification Number (VIN) physically located on said motor vehicle's dashboard and sticker, if present, on the inside of the driver-side door.

In the event that the name on the consumer's driver license, proof of insurance, and motor-vehicle registration documents visually match along with a visual match of the number on the motor-vehicle registration document and the VIN physically located on said motor vehicle's dashboard and sticker, if present, on the inside of the driver-side door, the service provider then records the VIN, year, make, model, color, odometer-reading, contact particulars, and other relevant motor vehicle information on the enterprise workstation.

This comparison-process provides verification that the motor vehicle placed for sale is, indeed, privately owned—an effective method to quickly identify used car dealers, use car brokers, and curbstoners who may ignore the express prohibition of participation and attempt to utilize the service by means of subterfuge or deception.

The service provider physically returns the consumer's driver license, proof of insurance, and motor-vehicle registration document.

Once said motor vehicle has been washed, detailed or, otherwise, prepped, the service provider digitally photographs said motor vehicle interior and exterior, including the dashboard VIN and driver-side VIN sticker, if present, and loads the photographs into the enterprise workstation.

The service provider ascertains whether the consumer wishes said motor vehicle to be placed on the central database in a classified advertisement format or in an auction format and, depending on which format, any asking price or reserve.

The service provider sets the appropriate format and records any additional, relevant information on the enterprise workstation.

The service provider performs a final verification of the accuracy of the information obtained from the consumer and that the digital photographs meet a reference standard of quality and format.

The service provider may issue a website password to the consumer at which time payment for the service is accepted.

The service provider uploads the relevant information and accompanying digital photographs in the desired format onto the central database by enterprise workstation, utilizing an assigned, encrypted, service-provider identification code.

Once the service provider has uploaded the formatted file onto the central database, website personnel visually review the file to confirm that the file has been correctly formatted, and that the file reflects contact information, the VIN, year, make, model, color and odometer-reading of said motor vehicle, also confirming that the digital photographs meet a reference standard of quality and format.

Once a consumer, interested in a particular listing on the central database, makes initial contact with a private party by one of the various available methods, a meeting may be arranged between the private seller and potential buyer at one of the brick-and-mortar locations during normal business hours for inspection, negotiation and final exchange.

For enhanced security, consumers may utilize the option of providing the service provider with photo-identification and contact particulars. Identification documents may be scanned and contact particulars may be recorded by date, time, and location, stored in the central database by means of the enterprise workstation, and maintained for a designated time after completion of the meeting, test-drive and consummation, if any, of final exchange.

Once the privately owned motor vehicle has been sold, the former owner may contact central database personnel for the purpose of immediate removal of the listing, thus, virtually eliminating dated inquiries.

A record of every listing of a privately owned motor vehicle for sale is batched and archived by personal identification information of the buyer and seller. This record provides a method to monitor the patronage and, thus, identify, isolate, and ban used car dealers, used car brokers, and curbstoners who may ignore the express prohibition of participation and attempt to utilize the service by means of subterfuge or deception.

### CONCLUSIONS, RAMIFICATIONS, AND SCOPE

Accordingly, the consumer has access to a branded service that is national in its reach while local in its execution whereby a privately owned motor vehicle is initially placed on the market in a quick, convenient, one-stop process. The electronic-commerce architecture enables the thousands of brick-and-mortar professional car care enterprises to morph into one hybrid model. The present invention provides the physical infrastructure integral to the process of buying and selling used motor vehicles. In accordance with tips for safety and crime prevention, the present invention has in place a method of documenting consumer meetings while providing a relatively safe and neutral location whereby consumers may meet to inspect, negotiate and finalize an exchange. The present invention has in place a method to quickly identify and enforce the prohibition against used car dealer participation in any fashion. The present invention has in place a method to quickly identify and enforce the prohibition against used car broker participation in any fashion. The present invention has in place a method to quickly identify and enforce the prohibition against curbstoner participation in any fashion. It also provides a branded service whereby consumers may arrive at true market value for a given motor vehicle by means of exclusive, real-time-inventory listings of privately owned motor vehicles and, finally, it provides a national platform for green-marketing the benefits of professional car care versus individual car care alternatives to an ecologically and environmentally conscious society.

Once the invention has established brand awareness, credibility, and reliability, the invention may ramify as a free tool to drive the core competency of the professional car care industry to a new level of efficiency and productivity. In other words, the invention may morph into a no-charge incentive and inducement (e.g., car wash club) for loyal patronage of the professional car care industry. Consequently, this type of incentive and inducement may ultimately contribute to expansion of the core market to mainstream consumers.

The comprehensive description above should not be construed as limiting the scope of the invention but as merely providing illustrations of some of the presently preferred embodiments of said invention.

Once the invention is in operation, a determination may be made that in order for the method of business to work more efficiently and expeditiously, the order of processes, as described above, may require changes, additions or eliminations. As an example, the process of taking digital photographs of a motor vehicle may be changed to taking streaming video so that the exterior of the motor vehicle may be rotated 360 degrees, a door(s) opened, and the interior of the motor vehicle rotated 360 degrees, in one fluid motion during a consumer's search for, and initial viewing of a motor vehicle of interest on the online site. [e.g., Edmunds.com to Provide Enhanced Automotive Photography to Car Industry, 80] Thus, the scope of the invention should be determined by the appended claims and their legal equivalents rather than by the examples given.

What is claimed is:

1. Electronic-commerce architecture and a professional car care industry means for marketing privately owned motor vehicles.

2. A method of marketing privately owned motor vehicles, comprising electronic-commerce architecture and a professional car care industry.

3. The method of claim 2 wherein said electronic-commerce architecture, comprising;
(a) a multi-protocol, wide-area network including a central database and professional car care enterprise computer-workstations;
(b) an interactive, service-mark branded, online site registered in a domain on a world-wide web; and
(c) further including any requisite hardware and application software necessary to conduct the operation and perform the service,
whereby the electronic-commerce architecture that enables the thousands of brick-and-mortar professional car care enterprises to morph into one hybrid model is composed,
whereby consumers can access said interactive, service-mark branded, online site for utilization of said method of buying and selling privately owned motor vehicles on an exclusive basis,
whereby consumers can take advantage of a market with an express prohibition and monitored enforcement against used car dealer participation, used car broker participation, or curbstoner participation in any fashion,
whereby consumers can take advantage of a nationwide, consumer-driven service where consumers may arrive at true market value for a given motor vehicle by means of exclusive, real-time-inventory listings of privately owned motor vehicles, and
whereby consumers can receive ecological and environmental information regarding the green-benefits of professional car care versus individual car care alternatives.

4. The method of claim 2 wherein said professional car care industry, an alliance of professional car care enterprises, comprising:
(a) car washes;
(b) truck and bus washes;
(c) car detailing shops;
(d) mobile car, truck and bus washes;
(e) self-service carwashes;
(f) waxing and polishing of motor vehicles; and
(g) further including any current, new, and future type of professional car care enterprise,
whereby the physical infrastructure integral to the process of buying and selling used motor vehicles is composed,
whereby private parties can take advantage of a quick, convenient, one-stop process for initiating the placement of a privately owned motor vehicle on the market, and
whereby consumers can take advantage of the physical infrastructure of the professional car care enterprises which provide a relatively safe and neutral meeting ground where consumers can inspect, negotiate, and finalize an exchange for a given motor vehicle.
